(19) United States
(12) Patent Application Publication
(10) Pub. No.: US 2011/0060559 A1
(43) Pub. Date: Mar. 10, 2011

(54) SPATIAL PLANNING SYSTEM

(75) Inventors: Rahinah Ibrahim, Selangor (MY); Ali Ghaffarian Hoseini, Selangor (MY); Rusli Abdullah, Selangor (MY)

(73) Assignee: UNIVERSITI PUTRA MALAYSIA, Selangor (MY)

(21) Appl. No.: 12/936,398

(22) PCT Filed: Apr. 14, 2009
(86) PCT No.: PCT/MY09/00053

§ 371 Date: Oct. 5, 2010

(30) Foreign Application Priority Data
Apr. 14, 2008 (MY) PI20081096

(51) Int. Cl. G06F 17/50

(52) U.S. Cl. 703/1

(57) ABSTRACT

The present invention relates to a spatial planning systems and methods thereof. The spatial planning system is conveniently comprised of an information interface means for storing information of at least two nodes (100), a spatial organizing component for arranging the stored information in order such that spatial relationship between two nodes (100) is established based on the information; a spatial relationship analyzing component for connecting at least one pair of nodes (100) which has functional relationship with each other with a link; a spatial displaying component for displaying the nodes (100) and the link between the two linked nodes (100) on a diagram; and a functional relationship maintainer component for maintaining the functional relationship of the at least one pair of linked nodes (100).

### FIELD OF THE INVENTION

The present invention relates to a spatial planning systems and methods thereof. More particularly, the present invention relates to a spatial planning systems and methods thereof that utilizes the centralization principals of the Social Network Analysis (SNA) in a conceptual design process for application in spatial diagramming processes of buildings, facility projects, construction, manufacturing and planning fields.

### BACKGROUND OF THE INVENTION

The conceptual design process is considered by many architects and construction experts as the most important phase in a building project. Large portion of the design decisions included in the conceptual design phase inherently influences the construction cost and schedule of the building project. Therefore, a project developer would always pay extra attention in the early planning of the conceptual stage to avoid any unnecessary wastage of cost and time.

Prior to the decision on the conceptual design, the developer would gather information on the requirements of the end user, or as in many cases, the project sponsors. For instance, the end user, which is the person that would occupy or utilize the completed building, would normally provide suggestions and ideas of the desired building (office or residence) based on his/her social-behavioral requirements. As an example, said user may desire that the dining room to be situated next to the living room. The architect's job then would be to translate the social behavioral requirements of the user to technical requirements instead in the architectural conceptual design phase. The user's requirements would be accordingly formalized into the actual architectural floor plan. For an architect, the conceptual design phase usually requires the architect to conduct bubble diagramming.

Architects still currently perform the bubble diagramming manually in order to coordinate spaces on an architectural floor plan before preparing the 3D volume of those spaces. Said preparation of 3D volume of the spaces is conducted using advanced visual modeling software currently available to architects. During the bubble diagramming process, rooms are arranged according to the decided movement order. At this stage, an irregular form such as a circle represents the rooms, and the two spaces (rooms) are linked to each other by a single line that shows the two-way behavioral movements between the spaces.

The bubble diagramming, in nature, is generally iterative such that the architect strives to develop the spatial layout with the minimum connection crossing. Cross connections that prevail may result to incidents such as the need to pass through the washroom in order to go from the kitchen to the dining room after a house is built.

Complex buildings may create multiple cross connections that can easily cause confusion and inefficiency during operations or occupancy. A hospital further exemplifies this situation due to its regulatory requirements due to health and safety reasons. The quarantined areas in a hospital cannot be mixed with the public waiting area.

As of nowadays, the architects may still need to conduct the bubble diagramming in a manual process not conveniently aided by any software. The manual process is arduous and not suitable, taking into the current context that many projects are carried in large scale and decisions have to be implemented rapidly. As a result, more experienced senior architects would be required to design on more complex buildings. A solution is therefore very much needed to overcome this drawback.

### SUMMARY OF THE INVENTION

Accordingly, there is provided a spatial planning system comprising an information interface means for storing information of at least two nodes, a spatial organizing component for arranging the stored information in order such that spatial relationship between two nodes is established based on the information; a spatial relationship analyzing component for connecting at least one pair of nodes which has functional relationship with each other with a link; a spatial displaying component for displaying the nodes and the link between the two linked nodes on a diagram; and a functional relationship maintainer component for maintaining the functional relationship of the at least one pair of linked nodes.

The nodes have alterable spatial requirements thereof and spatial relationship with another node based on the information, and said information would be applied to a design plan. The functional relationship maintainer component would maintain the functional relationship between a pair of linked nodes after at least one of said pair of linked nodes has been relocated, or after the spatial requirement of at least one of said pair of linked nodes has been altered. The display of the link between the pair of linked nodes also assists a user to identify cross connections of multiple nodes. In addition to that, the spatial planning system automates the bubble diagramming into an architectural floor layout plan.

The present invention also relates to a spatial planning method that is implemented on a spatial planning system. The spatial planning method comprises the steps of storing information of at least two nodes, arranging the stored information in order, such that spatial relationship between two nodes is established based on the information; connecting at least one pair of nodes which has functional relationship with each other with a link; displaying the nodes and the link between the two linked nodes on a diagram; and maintaining the functional relationship of the at least one pair of linked nodes such that said functional relationship thereof is maintained after at least one of said pair of linked nodes has been relocated, and after the spatial requirement of at least one of said pair of linked nodes is altered. In the step of storing information of at least two nodes, the nodes each have alterable spatial requirements thereof and spatial relationship with another node based on the information. The information, according to the step of storing information, would be applied to a conceptual design plan. The information stored by a user is augmentable at any time during the conceptual design process without causing the link between two nodes to be disconnected.

It is an object of the present invention to provide a spatial planning system and methods thereof that allow the functional relationship to be maintained between at least two spaces or rooms, wherein any one space could have been relocated before to a different location.

It is also an object of the present invention to provide a spatial planning system and methods thereof that each node therein is capable of carrying information and early decisions; said information could be augmented any time during the lifecycle of the building project.

It is further an object of the present invention to provide a spatial planning system and method thereof that incorporates the centralization level of Social Network Analysis (SNA) in an application of the spatial planning.

It is also a further object of the present invention to automate the bubble diagramming in the architectural and planning design process.

It is a final object of the present invention to resolve architects' visualization problems when conducting the spatial planning exercise with their clients; save time for the architects enabling them to focus on the building design's aesthetics.

The present invention consists of certain novel features and a combination of parts hereinafter fully described and illustrated in the accompanying drawings and particularly pointed out in the appended claims; it being understood that various changes in the details may be without departing from the scope of the invention or sacrificing any of the advantages of the present invention.

### BRIEF DESCRIPTION OF THE DRAWINGS

For the purpose of facilitating an understanding of the invention, there is illustrated in the accompanying drawings the preferred embodiments from an inspection of which when considered in connection with the following description, the invention, its construction and operation and many of its advantages would be readily understood and appreciated.

FIG. 1 shows the spatial planning system's feature having matrices with space names, and the corresponding visual display of DOTs (equivalent of nodes).

FIG. 2 shows the spatial planning system's feature having matrices with space names and their corresponding connections, and the visual display showing DOTs and LINKs (equivalent of functional relationships).

FIG. 3 shows the spatial planning system's feature having matrices with space names, and their corresponding connections, and the visual display showing prioritized DOTs (equivalent of spatial nodes) and prioritized LINKs (equivalent of functional relationships).

FIG. 4 shows the spatial planning system's feature having matrices with space names, and their corresponding connections, and the visual display showing DOTs and LINKs (equivalent of functional relationships) in one layout plan.

FIG. 5 shows the spatial planning system's feature having matrices with space names, and their corresponding connections, and the visual display showing DOTs and LINKS (equivalent of functional relationships), but in another layout plan option.

### DETAILED DESCRIPTION OF THE PREFERRED EMBODIMENTS

The present invention relates to a spatial planning system and the method thereof. More particularly, the present invention relates to a spatial planning systems and methods thereof that utilizes the centralization principals of the Social Network Analysis (SNA) in a conceptual design process for application in architectural spatial planning exercises of buildings, construction, manufacturing and planning fields. Hereinafter, the spatial planning system shall be described according to the preferred embodiments of the present invention and by referring to the accompanying description and drawings. However, it is to be understood that limiting the description to the preferred embodiments of the invention and to the drawings is merely to facilitate discussion of the present invention and it is envisioned that those skilled in the art may devise various modifications without departing from the scope of the appended claim.

The spatial planning system of the present invention comprises an information interface means for storing information of at least two nodes (100), a spatial organizing component for arranging the stored information in order such that spatial relationship between two nodes (100) is established based on the predefined information, a spatial relationship analyzing component for connecting at least one pair of nodes (100) which has functional relationship with each other with a link, a spatial displaying component for displaying the nodes (100) and the link between the two linked nodes (100) on a diagram, and a functional relationship maintainer component for maintaining the functional relationship of the at least one pair of linked nodes (100).

The spatial planning method that is implemented on a spatial planning system comprises the steps of storing information of at least two nodes (100), arranging the stored information in order such that spatial relationship between two nodes (100) is established based on the information, connecting at least one pair of nodes (100) which has functional relationship with each other with a link, displaying the nodes and the link between the two linked nodes (100) on a diagram, and maintaining the functional relationship of the at least one pair of linked nodes (100) such that said functional relationship thereof is maintained after at least one of said pair of linked nodes (100) is relocated, and after the spatial requirement of at least one of said pair of linked nodes (100) is altered.

The nodes each constitute alterable spatial requirements and spatial relationship with another node (100). A user is required to input the information via the information storage means. The stored information would then be applied to a design plan. The link between the pair of linked nodes (100) is also displayed to enable a user to easily identify the cross connections of multiple nodes (100). The functional relationship between two linked nodes (100) is usually maintained after one of the two linked nodes (100) has been moved or after the spatial requirement of one of the pair of linked nodes (100) has been altered. The system and the method thereof will be hereinafter further described in greater detail.

Under several unprecedented studies, the architectural conceptual design process has been observed to yield similar nodes (100) and structural relationships with the centralization level of the Social Network Analysis (SNA). A SNA tool therefore can be potentially applied to enable architects to make changes by moving any spaces on a floor plan while safely maintaining their spatial relationships to other spaces. As a result, a model using a SNA tool has been developed to facilitate spatial diagramming visualization during conceptual design phase.

On a brief note, social network analysis dissects relationships in terms of nodes and ties. In the network, the nodes (100) would act as individual objects whilst the ties represent relationships between the objects. In short, the SNA shows how the nodes (100) are being connected via the ties.

Structural nodal relationships are established using the SNA adaptation during the architectural conceptual design. In the development of the spatial planning system, the arbitrary nodal coordinates are linked with an object that represents a space. The nodal coordinates are linked in such a manner to establish “space” on a horizontal plan whereby the horizontal plan would represent for instance, a floor level in a building project. In developing the spatial planning system, a line would be drawn between the two sets of coordinates if two spaces are identified to have connection between them. The single line representing the relationship has an arrowhead at both ends representing a two-way relationship between the two spaces. Said drawn line is said to be representing the relationship between the objects. The developed system also allows a user to move one node (100) at a time anywhere on the horizontal plane without the information of the link being lost or disconnected at each move.

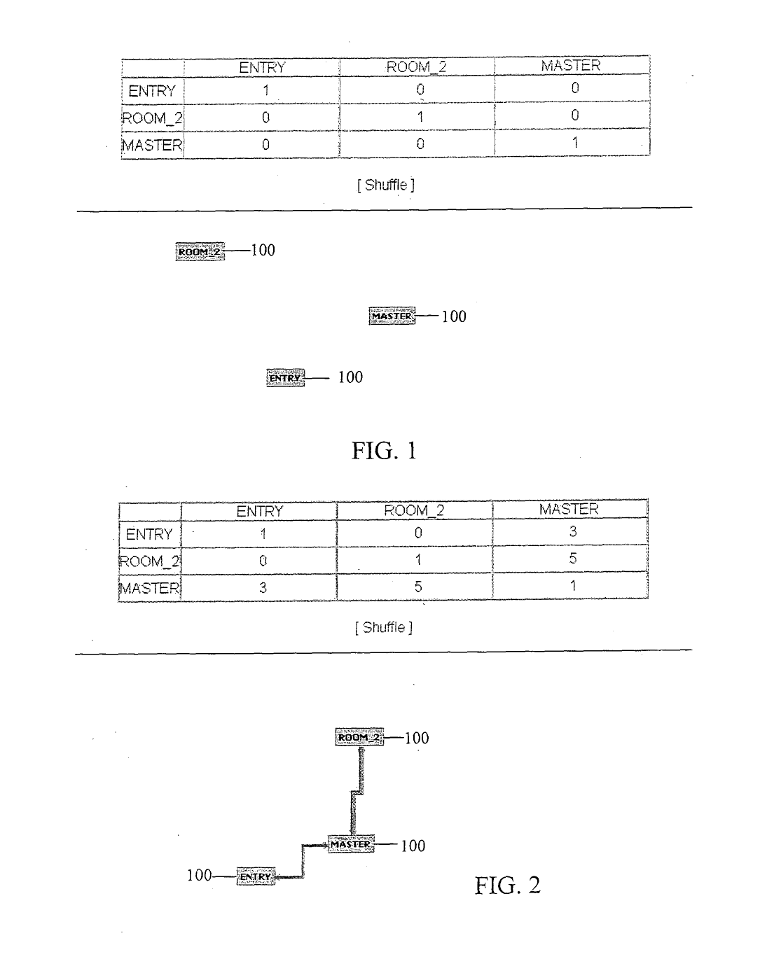

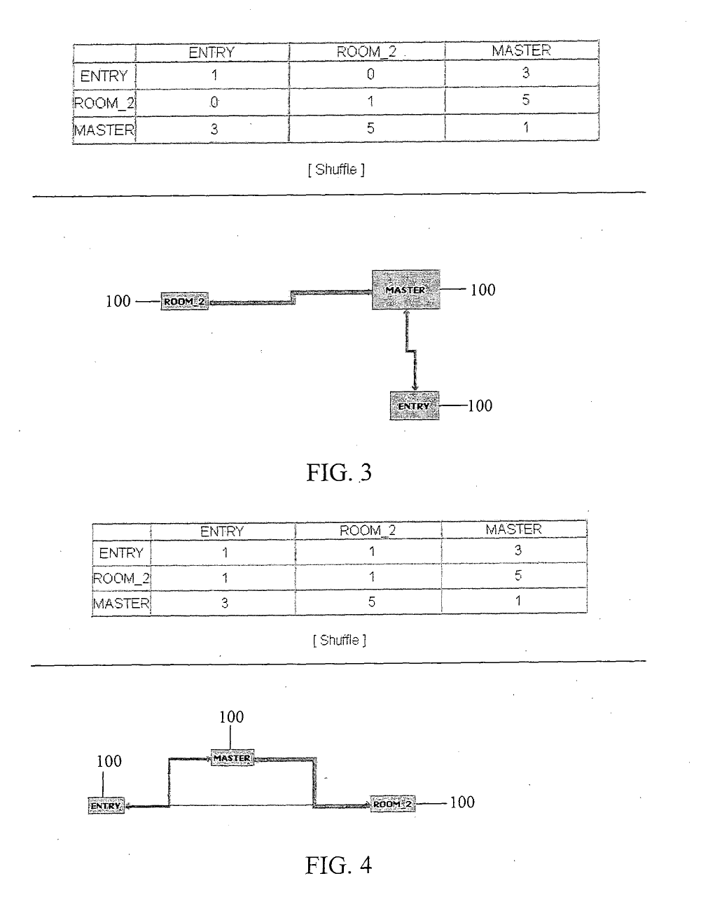

According to the most preferred embodiment, with reference to the FIG. 1 and FIG. 2, the spatial planning system would take the input from the user in a matrix table format and automatically produces a visual of spaces with the required connections (also referred as the functional relationships). According to FIGS. 2 and 3, the outcome of the information fed into the matrix table format would be the visual output where the diagram with the conceptual design plan is shown. This would ensure that the user does not miss any required connection (the functional relationship) whenever the information is inputted or a space is moved on the floor plan. As described, in the spatial planning system, a “NODE” would represent a space or a room with information about it's coordinates' location, dimensioning values, etc. If one node (100) has a connection or a functional relationship with another node (100) as one of the requirement inputted by a user, a line referred as “LINK” would represent said relationship, with the two sets of coordinates connected together.

The spatial planning system automates the bubble diagramming process manually performed by architects as an only conventional method during architectural and planning design process. The spatial planning system automatically connects the required spaces with regards to the functional relationship between two linked nodes (100). The system allows designers alike to conveniently arrange spaces on a plane prior to extending 3D volumes on these spaces on the same plane. The visual display assists designers to identify cross connections of multiple NODES on a plane. Based on social network analysis principals, the spatial planning system receives inputs in a matrix format and visually displays spaces and their connections (functional relationship) in the form of functional NODEs and functional LINKs on a horizontal plane. A NODE represents a space, and has its own attributes on the plane. A LINK represents a functional connection between the two spaces, and is a line connecting the two NODEs' location identifiers. The spatial planning system of the present invention, with presence of the functionality, maintains the functional connections between functional spaces whenever designers move the NODEs on a plane.

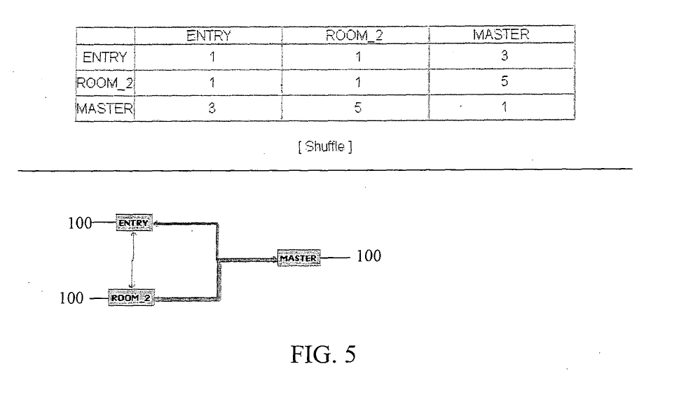

Referring now to FIGS. 4 and 5, in the system, a node (100) can only be moved one at a time such that when a node (100) is moved, all links between the linked nodes (100) would be temporarily disconnected and all the previous links would be connected again forming a new diagram when the movement ceased. This feature allows the designer to produce two different spatial layouts, but using the same predefined information. The spatial planning system also equipped with another feature which is the nodes clustering component. The user may group several nodes (100) into one cluster. Several clusters may be grouped on one horizontal plane or several horizontal planes. If the cluster groups are on several horizontal planes, specific nodes on several horizontal planes could be linked together to form vertical relationships. For instance, a staircase in a double-story house. This means that the nodes of the corresponding cluster on said several horizontal planes could be linked to each other to form a cluster-node relationship. The link between two cluster-nodes (100) would be displayed by the spatial display component on the diagram.

Spatial diagramming exercises for a simple medium sized building consume at least one month to complete satisfactorily by an average architect. For a more complex building like a hospital, senior architects are mostly called upon to complete the design phase. As such, the spatial planning system, which uses artificial intelligence to automate the architectural and planning design process in the building, construction, manufacturing, and planning fields, is needed. The benefit of this system is that the system is adaptable in any field which involves spatial planning. Any architect would be able to maintain the relationships between the required spaces no matter how rigorous they move the spaces anywhere on a horizontal plane. This capability will save a lot of time for architects, and would enable them to concentrate on the building design aesthetics since they are no longer worried about ensuring the maintenance of the connections manually. The tasks involved in the architectural conceptual design process are no longer arduous.

While in the foregoing specification this invention has been described in relation to certain preferred embodiments thereof and many details have been set forth for purpose of illustration, it will be apparent to those skilled in the art that the invention is susceptible to additional embodiments and that certain of the details described herein can be varied considerably without departing from the basic principles of the invention.

1. A spatial planning system comprising:
an information interface means for storing information of at least two nodes, the nodes each having alterable spatial requirements thereof and spatial relationship with another node based on the information, and said information is applied to a design layout plan;
a spatial organizing component for arranging the stored information in order, such that spatial relationship between two nodes is established based on the information;
a spatial relationship analyzing component for connecting at least one pair of nodes which has functional relationship with each other with a link;
a spatial displaying component for displaying the nodes and the link between the two linked nodes on a diagram;
a functional relationship maintainer component for maintaining the functional relationship of the at least one pair of linked nodes, said functional relationship thereof is maintained after at least one of said pair of linked nodes is relocated, and after the spatial requirement of at least one of said pair of linked nodes is altered; and
a nodes clustering component for clustering several nodes into at least one cluster wherein the user stores the information of the at least one cluster of nodes via the information interface means;
wherein the display of the link between the pair of linked nodes assists a user to identify cross connections of multiple nodes and the information stored by a user is augmentable at any time during the conceptual design process; and the design plan has multiple planes in such a manner that the nodes each are located at the corresponding plane on the diagram.

2. (canceled)

3. A spatial planning system according to claim 1, wherein the spatial displaying component displays the nodes and the links on a corresponding plane.

4. A spatial planning system according to claim 3, wherein the corresponding plane is a horizontal plane such that a pair of nodes which has the functional relationship on the same horizontal plane to each other is connected with the link that connects the coordinates of said both nodes together.

5. (canceled)

6. A spatial planning system according to claim 1, wherein the at least one cluster is located on at least one horizontal plane.

7. A spatial planning system according to claim 6, wherein the clusters of nodes are located on several horizontal planes, the nodes of the corresponding cluster on said several horizontal planes are linkable to each other to form a cluster-node relationship such that the link between two cluster-nodes are displayed by the spatial display component on the diagram.

8. A spatial planning system according to claim 1, wherein the display of the link between the pair of linked nodes assists a user to identify cross connections of multiple nodes on a horizontal plane.

9. A spatial planning system according to claim 1, wherein the spatial planning system employs the centralization principals of the Social Network Analysis for application in the architectural conceptual design.

10. A spatial planning system according to claim 1, wherein only one node is allowed to be altered or moved at a time such that when a node is moved, all links connected to that node would be temporarily disconnected and such that when the movement ceased, the previous links would be connected again forming a new diagram.

11. A spatial planning system according to claim 10, wherein the node is moved on a horizontal plane.

12. A spatial planning system according to claim 9, wherein the spatial planning system is utilized to enable automation of a bubble diagramming into an architectural spatial planning design process.

13. A spatial planning system according to claim 12, wherein the node represents a space or a room such that the node is a spatial object which carries multiple information, said information consists of the location of the spatial object, the physical properties, dimensioning values and other related information, and said node is represented on an architectural conceptual design plan.

14. A spatial planning system according to claim 12, wherein the information interface means comprises a matrix table format on which the information of the user's input is tabulated on a matrix table format such that the spatial relationship between two nodes is established on the matrix table format.

15. A spatial planning system according to claim 12, wherein the nodes each are represented on the diagram as NODE.

16. A spatial planning system according to claim 12, wherein the nodes each are represented on the diagram as NODE; and the functional relationship between two linked nodes is represented by a line called LINK on the diagram, connecting the two sets of coordinates together.

17. A spatial planning system using the centralization principals of the Social Network Analysis for application in a conceptual design plan comprising:
an information interface means for storing information of at least two nodes, the nodes each having alterable spatial requirements thereof and spatial relationship with another node based on the information, and said information is applied to a conceptual design plan;
a spatial organizing component for arranging the stored information in order, such that spatial relationship between two nodes is established based on the information;
a spatial relationship analyzing component for connecting at least one pair of nodes which has functional relationship with each other with a link;
a spatial displaying component for displaying the nodes and the link between the two linked nodes on a diagram;
a functional relationship maintainer component for maintaining the functional relationship of the at least one pair of linked nodes, said functional relationship thereof is maintained after at least one of said pair of linked nodes is relocated, and after the spatial requirement of at least one of said pair of linked nodes is altered; and a nodes clustering component for clustering several nodes into at least one cluster wherein the user stores the information of the at least one cluster of nodes via the information interface means;
wherein the display of the link between the pair of linked nodes assists a user to identify cross connections of multiple nodes; the information stored by a user is augmentable at any time during the conceptual design process; and the conceptual design plan has multiple planes in such a manner that the nodes and the links are located at the corresponding plane on the diagram.

18. (canceled)

19. A spatial planning system according to claim 17, wherein the corresponding plane is a horizontal plane such that a pair of nodes which has the functional relationship on the same horizontal plane to each other is connected with the link that connects the coordinates of said both nodes together.

20. (canceled)

21. A spatial planning system according to claim 17, wherein the at least one cluster is located on at least one horizontal plane; and wherein the clusters of nodes are located on several horizontal planes, the nodes of the corresponding cluster on said several horizontal planes are linkable to each other to form a cluster-node relationship such that the link between two cluster-nodes are displayed by the spatial display component on the diagram.

22. A spatial planning system according to claim 17, wherein only one node is allowed to be altered or moved at a time such that when a node is moved, all links between would be temporarily disconnected and such that when the movement ceased, the previous links would be connected again forming a new diagram.

23. A spatial planning system according to claim 22, wherein the node is moved on a horizontal plane.

24. A spatial planning system according to claim 17, wherein the node represents a space or a room such that the node is a spatial object which carries multiple information, said information consists of the location of the spatial object, the physical properties, dimensioning values and other related information, and said node is represented on a conceptual design plan.

25. A spatial planning system according to claim 17, wherein the information interface means comprises a matrix table format on which the information of the user's input is tabulated on a matrix table format such that the spatial relationship between two nodes is established on the matrix table format.

26. A spatial planning method that is implemented on a spatial planning system comprising the steps of:
(a) storing information of at least two nodes, the nodes each having alterable spatial requirements thereof and spatial relationship with another node based on the information, and said information is applied to a conceptual design plan;
(b) arranging the stored information in order, such that spatial relationship between two nodes is established based on the information;
(c) connecting at least one pair of nodes which has functional relationship with each other with a link;
(d) displaying the nodes and the link between the two linked nodes on a diagram, the conceptual design plan has multiple planes in such a manner that the nodes and the links are located at the corresponding plane on the diagram: and
(e) maintaining the functional relationship of the at least one pair of linked nodes such that said functional relationship thereof is maintained after at least one of said pair of linked nodes is relocated, and after the spatial requirement of at least one of said pair of linked nodes is altered; and
(f) clustering nodes into at least one cluster wherein the user stores the information of the at least one cluster of nodes via an information interface means;
the display of the link between the pair of linked nodes assists a user to identify cross connections of multiple nodes, and the information stored by a user is augmentable at any time during the conceptual design process.

27. (canceled)

28. A spatial planning method according to claim 26, wherein the corresponding plane is a horizontal plane.

29. (canceled)

30. A spatial planning method according to claim 26, wherein in the step of clustering nodes into at least one cluster, the at least one cluster is located on at least one horizontal plane; and wherein the clusters of nodes are located on several horizontal planes, the nodes of the corresponding cluster on said several horizontal planes are linkable to each other to form a cluster-node relationship such that the link between two cluster-nodes are displayed by the spatial display component on the diagram.

31. A spatial planning method according to claim 26, wherein only one node is allowed to be altered or moved at a time such that when a node is moved, all links between would be temporarily disconnected and such that when the movement ceased, the previous links would be connected again forming a new diagram.

32. A spatial planning method according to claim 31, wherein the node is moved on a horizontal plane.

33. A spatial planning method according to claim 26, wherein in the step of storing information, the node is a spatial object which carries multiple information, said information consists of the location of the spatial object, the physical properties, dimensioning values and other related information, and said node is represented on a conceptual design plan.

34. A spatial planning method according to claim 26, wherein the step of storing information comprises the step of storing information in a matrix table format on which the information of the user's input is tabulated on a matrix table format such that the spatial relationship between two nodes is established on the matrix table format.

35. A spatial planning method according to claim 26, wherein the centralization principals of the Social Network Analysis is utilized with the methods for application in an architectural conceptual design process.
